(19) United States
(12) Patent Application Publication
(10) Pub. No.: US 2015/0343634 A1
(43) Pub. Date: Dec. 3, 2015

(54) ROBOT, ROBOT SYSTEM, AND CONTROL METHOD

(71) Applicant: Seiko Epson Corporation, Tokyo (JP)

(72) Inventor: Yuki KIYOSAWA, Matsumoto (JP)

(21) Appl. No.: 14/727,092

(22) Filed: Jun. 1, 2015

(30) Foreign Application Priority Data
Jun. 2, 2014 (JP) 2014-114421

(51) Int. Cl. B25J 9/16; B25J 15/08; B25J 15/00

(52) U.S. Cl. CPC B25J 9/1612; B25J 15/0004; B25J 9/1679; B25J 15/08; Y10S 901/31

(57) ABSTRACT

A robot includes a hand including a plurality of finger sections and a placing section and a control unit configured to control the hand. The plurality of finger sections respectively include contact surfaces that come into contact with an object. After causing the plurality of finger sections to grip the object, the control unit moves the hand until the contact surfaces of the plurality of finger sections come to a position higher than the placing section in the gravity direction, causes the plurality of finger sections to release the gripping of the object, and causes the plurality of finger sections to grip the object again.

### BACKGROUND

1. Technical Field

The present invention relates to a robot, a robot system, a control apparatus, and a control method.

2. Related Art

In recent years, various configurations have been proposed as a robot hand. As the robot hand, there has been proposed, for example, a hand including four finger blocks provided with finger members, a driving mechanism that moves the finger blocks in a first direction or a second direction, a plurality of peripheral blocks connected to the driving mechanism by drive shafts, and a plurality of guide shafts inserted into sliding holes of the peripheral blocks and capable of sliding. The finger blocks are located at four corners of a square in plan view from a third direction. The peripheral blocks and the guide shafts are located along four sides of the square. The center of the driving mechanism is located in the center of the square. Two sides among the sides are parallel to the first direction and the other two sides among the sides are parallel to the second direction. The first direction, the second direction, and the third direction are orthogonal to one another. The hand includes an urging member that urges the finger blocks in a moving direction in which the finger blocks are moved (e.g., JP-A-2014-18909 (Patent Literature 1)).

However, when an object is gripped by the hands including the plurality of finger sections explained above, the hand sometimes cannot grip the object in a desired posture. For example, when the hand grips the object, since the object to be gripped is light in weight, the object is sometimes moved by contact with the finger sections or the like. As a result, the hand cannot grip the object in a desired posture. The posture of the gripped object is sometimes different from a posture recognized by a robot system.

### SUMMARY

An advantage of some aspects of the invention is to provide a robot, a robot system, a control apparatus, and a control method that can correct a gripping posture of an object.

One aspect of the invention is directed to a robot including: a hand including a plurality of finger sections and a placing section; and a control unit configured to control the hand. The plurality of finger sections respectively include contact surfaces that come into contact with an object. After causing the plurality of finger sections to grip the object, the control unit moves the hand until the contact surfaces of the plurality of finger sections come to a position higher than the placing section in the gravity direction, causes the plurality of finger sections to release the gripping of the object, and causes the plurality of finger sections to grip the object again.

With this configuration, the robot releases the object from the gripping and grips the object again. That is, the robot re-holds the object. Therefore, the robot can correct the gripping posture of the object.

In another aspect of the invention, in the robot described above, the object may be placed on the placing section when the gripping is released by the plurality of finger sections.

With this configuration, the robot places the released object. Therefore, the robot can grip the released object again irrespective of the shape of the object.

In another aspect of the invention, in the robot described above, at least two of the plurality of finger sections may come into contact with the object after the release.

With this configuration, the plurality of finger sections place the released object. Therefore, the robot can grip the released object again without addition of a new component for placing the object.

In another aspect of the invention, in the robot described above, after the release of the gripping, the robot may cause the plurality of fingers to grip the object again by moving the plurality of fingers sections respectively to specific points while maintaining parallelism of the surface of the object in contact with the plurality of finger sections or the placing section and the upper surfaces of the plurality of finger sections.

With this configuration, when gripping the object again, the robot can match the action center of the hand and the center of the cross section of the object.

Still another aspect of the invention is directed to a robot system including: a robot including a hand including a plurality of finger sections and a placing section; and a control unit configured to control the hand. The plurality of finger sections respectively include contact surfaces that come into contact with an object. After causing the plurality of finger sections to grip the object, the control unit moves the hand until the contact surfaces of the plurality of finger sections come to a position higher than the placing section in the gravity direction, causes the plurality of finger sections to release the gripping of the object, and causes the plurality of finger sections to grip the object again.

With this configuration, in the robot system, the control unit controls the robot to release the object from the gripping and grip the object again. That is, the robot re-holds the object. Therefore, the robot system can correct the gripping posture of the object.

Yet another aspect of the invention is directed to a control apparatus that operates a robot including: a hand including a plurality of finger sections and a placing section. The plurality of finger sections respectively include contact surfaces that come into contact with an object. After causing the plurality of finger sections to grip the object, the control apparatus moves the hand until the contact surfaces of the plurality of finger sections come to a position higher than the placing section in the gravity direction, causes the plurality of finger sections to release the gripping of the object, and causes the plurality of finger sections to grip the object again.

With this configuration, the control apparatus controls the robot to release the object from the gripping and grip the object again. That is, the robot re-holds the object. Therefore, the robot system can correct the gripping posture of the object.

Still yet another aspect of the invention is directed to a control method for operating a robot including: a hand including a plurality of finger sections and a placing section. The plurality of finger sections respectively include contact surfaces that come into contact with an object. The control method includes: causing the plurality of finger sections to grip the object; moving the hand until the contact surfaces of the plurality of finger sections come to a position higher than the placing section in the gravity direction; releasing the gripping of the object by the plurality of finger sections; and causing the plurality of finger sections to grip the object again.

With this configuration, the robot is controlled to release the object from the gripping and grip the object again. That is, the robot re-holds the object. Therefore, the robot can correct the gripping posture of the object.

Consequently, in the robot, the robot system, the control apparatus, and the control method, the finger sections of the hand release the object from the gripping and grip the object again. Therefore, the robot, the robot system, the control apparatus, and the control method can correct the gripping posture of the object.

### BRIEF DESCRIPTION OF THE DRAWINGS

The invention will be described with reference to the accompanying drawings, wherein like numbers reference like elements.

FIG. 1 a diagram showing the schematic configuration of a robot system according to an embodiment of the invention.

FIGS. 2A to 2C are diagrams schematically showing the operations of hands included in the robot according to the embodiment of the invention.

FIG. 3 is a diagram showing an example of the schematic hardware configuration of a control apparatus according to the embodiment of the invention.

FIG. 4 is a block diagram showing the schematic functional configuration of the control apparatus according to the embodiment of the invention.

FIG. 5 is a flowchart for explaining an example of a flow of re-holding processing by the control apparatus according to the embodiment of the invention.

FIGS. 6A to 6E are diagrams for explaining a first example of the operation by a robot system according to the embodiment of the invention.

FIGS. 7A and 7B are top views showing a positional relation between finger sections of the hand included in the robot according to the embodiment of the invention and a target object.

FIGS. 8A to 8D are diagrams for explaining a second example of the operation by the robot system according to the embodiment of the invention.

### DESCRIPTION OF EXEMPLARY EMBODIMENTS

An embodiment of the invention is explained below with reference to the drawings.

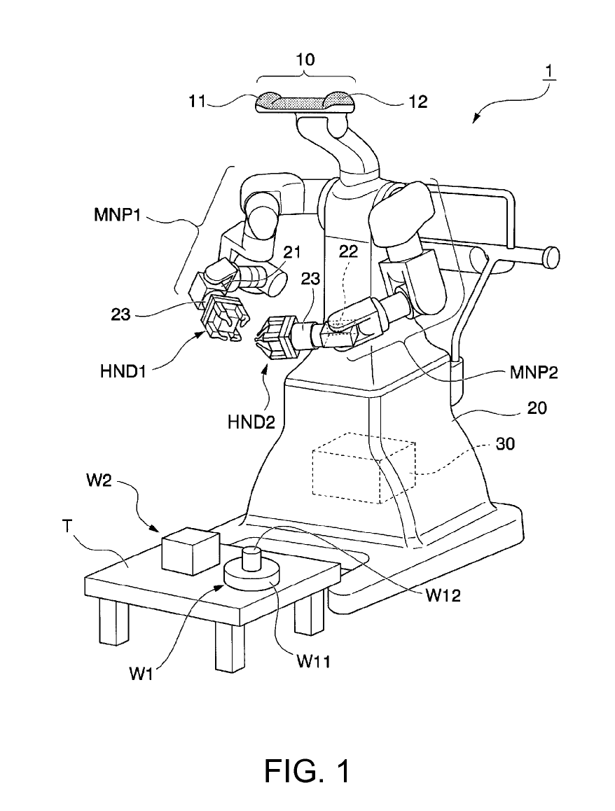

FIG. 1 is a diagram showing the schematic configuration of a robot system 1 according to this embodiment.

The robot system 1 includes a robot 20 including two gripping sections (a hand HND1 and a hand HND2), which include finger sections and placing sections, and a control apparatus 30.

In the robot system 1, after gripping a target object, the robot 20 moves the hand HND1 or the hand HND2 until contact surfaces of the finger sections and the target object come to a position higher than the placing section in the gravity direction. The robot 20 releases the target object from the gripping and grips the target object again. In the following explanation, the series of processing is sometimes referred to as “re-holding processing”. With the re-holding processing, the robot 20 grips the target object, which is gripped by the hand HND1 or the hand HND2, again in a desired posture. Therefore, the robot 20 can correct the gripping posture of the target object. Concerning the position and the posture of the target object with respect to the hand HND1 or the hand HND2, the robot system 1 can reduce an error between an actual state and recognition by the robot system 1.

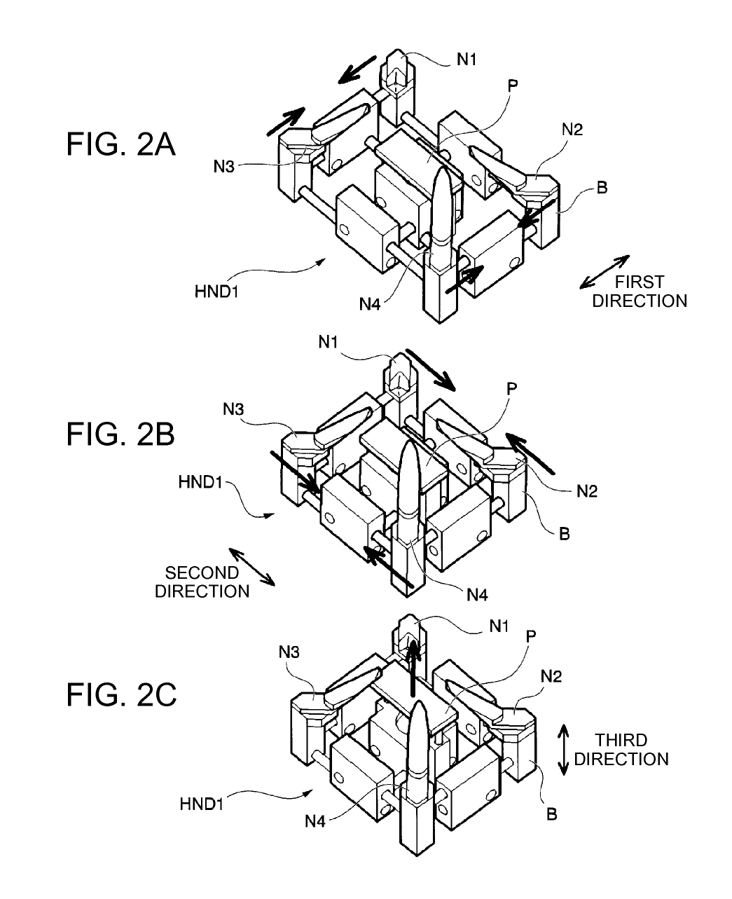

The target object refers to an object gripped by the hand HND1 or the hand HND2. Two kinds of target objects W1 and W2 are explained. The target object W1 is an object including a protrusion W12 and a substrate W11 from which the protrusion W12 extends. The hand HND1 or the hand HND2 is capable of placing the target object W1 according to contact of finger sections N1 to N4 (FIGS. 2A to 2C) included in the hand HND1 or the hand HND2 and the substrate W11. The target object W2 is an object including, as a bottom surface, a plane or a curved surface that can stabilize the position and the posture of the target object 2 when the target object W2 is placed on a horizontal plane. The hand HND1 or the hand HND2 is capable of placing the target object W2 according to contact with the plane or the curved surface. In the following explanation, an example is explained in which the target object W1 is an object having a stepped cylindrical shape such as a gear and the target object W2 is an object having a rectangular parallelepiped shape. However, the shape of the target object gripped by the hand HND1 or the hand HND2 is not limited to the shapes explained above and may be, for example, a bar shape. The target object W1 or the target object W2 is placed on a workbench T.

In the following explanation, the schematic configurations of the apparatuses included in the robot system 1 are explained.

The robot 20 is a double arm robot including an image pickup unit 10, a first movable image-pickup unit 21, a second movable image-pickup unit 22, a force sensor 23, the hand HND1, the hand HND2, a manipulator MNP1, a manipulator MNP2, and a not-shown plurality of actuators. The double arm robot indicates a robot including two arms, i.e., an arm configured by the hand HND1 and the manipulator MNP1 (hereinafter referred to as “first arm”) and an arm configured by the hand HND2 and the manipulator MNP2 (hereinafter referred to as “second arm”).

Note that the robot 20 may be a single arm robot instead of the double arm robot. The single arm robot indicates a robot including one arm and indicates, for example, a robot including at least one of the first arm and the second arm. The robot 20 further incorporates the control apparatus 30 and is controlled by the incorporated control apparatus 30. Note that the robot 20 may be controlled by the control apparatus 30 set on the outside instead of the incorporated control apparatus 30.

The first arm is a six-axis vertical articulated type. A supporting table, the manipulator MNP1, and the hand HND1 are capable of performing operation in a six-axis degree of freedom according to associated operation by the actuators. The first arm includes the first movable image-pickup unit 21 and the force sensor 23.

Note that the first arm may operate in five degrees of freedom (five axes) or less or may operate in seven degrees of freedom (seven axes) or more.

FIGS. 2A to 2C are diagrams schematically showing the operations of the hand HND1 and the hand HND2 included in the robot 20.

Each of the hand HND1 and the hand HND2 according to this embodiment includes four finger sections N1 to N4, a base B from which the finger sections N1 to N4 extend, and a placing section P. A publicly-known configuration is applicable to the hand HND1 and the hand HND2. In this embodiment, the robot hand described in Patent Literature 1 is adopted as the hand HND1 and the hand HND2. Explanation of the detailed configuration of the hand HND1 and the hand HND2 is omitted.

The hand HND1 and the hand HND2 operate in three directions illustrated in FIGS. 2A to 2C.

In a movement in a first direction shown in FIG. 2A, the hand HND1 and the hand HND2 grip or release the target object W1 or the target object W2 by moving in a direction in which the finger section N1 and the finger section N3 move close to or away from each other and the finger section N2 and the finger section N4 move close to or away from each other.

In a movement in a second direction shown in FIG. 2B, the hand HND1 and the hand HND2 grip or release the target object W1 or the target object W2 by moving in a direction in which the finger section N1 and the finger section N2 move close to or away from each other and the finger section N3 and the finger section N4 move close to or away from each other.

In a movement in a third direction shown in FIG. 2C, the hand HND1 and the hand HND2 project the placing section P in a direction in which the finger sections N1 to N4 extend from the base B, that is, in a direction perpendicular to the upper surface of the placing section P. On the placing section P, a target object released from gripping can be placed when the position of the placing section P is present in a position lower than the contact surfaces of the finger sections N1 to N4 and the target object in the gravity direction. Even in a state in which the target object W1 or the target object W2 is not in contact with the finger sections N1 to N4, the target object W1 or the target object W2 can be placed on the placing section P. The upper surface of the placing section P is parallel to a surface defined by the first direction and the second direction.

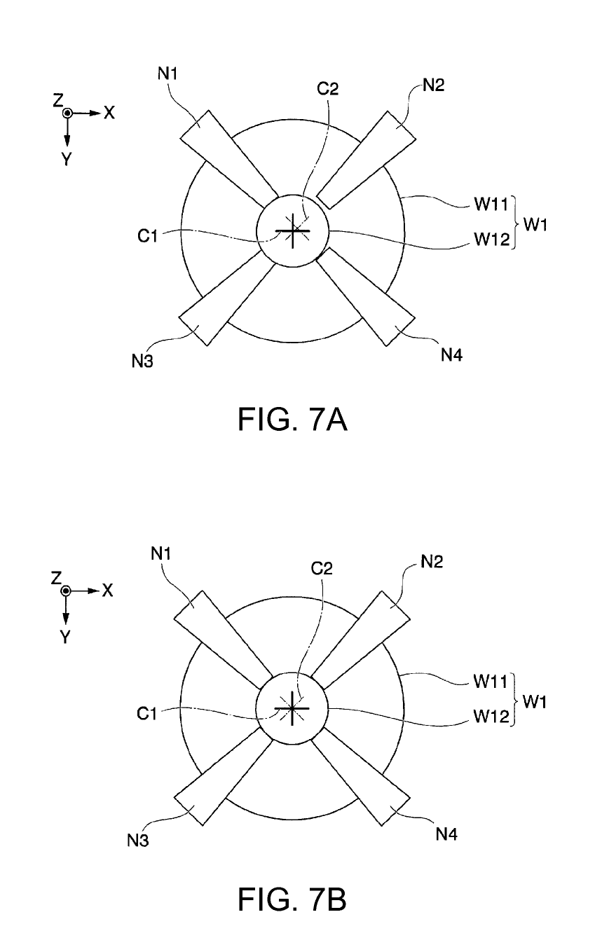

Note that the hand HND1 and the hand HND2 may include a configuration different from the configuration explained above. Each of the hand HND1 and the hand HND2 may include two, three, or four or more finger sections. The shape of the finger sections is not limited to the shape shown in the figure. For example, as shown in FIGS. 7A and 7B, the finger sections may have a hook-like shape capable of gripping the target object W1 or the target object W2 by pressing end portions thereof against the target object W1 or the target object W2. Each of the hand HND1 and the hand HND2 may include one finger section. In this case, for example, the hand HND1 and the hand HND2 may be configured to hold the target object W1 or the target object W2 between the finger section and a flat plate or a surface such as a curved surface corresponding to the finger section for pressing. The placing section P may be fixed to the base B and not move or may be integrated with the base B. The hand HND1 and the hand HND2 do not have to include the placing section P. In the following explanation, unless specifically noted otherwise, the level of the position in the gravity direction is described as upper and lower.

The first movable image-pickup unit 21 is, for example, a camera including a CCD (Charge Coupled Device) or a CMOS (Complementary Metal Oxide Semiconductor), which is an image pickup device that converts condensed light into an electric signal.

The first movable image-pickup unit 21 is communicably connected to the control apparatus 30 by a cable. Wired communication via the cable is performed according to a standard such as an Ethernet (registered trademark) or a USB (Universal Serial bus). Note that the first movable image-pickup unit 21 and the control apparatus 30 may be connected by radio communication performed according to a communication standard such as Wi-Fi (registered trademark).

As shown in FIG. 1, the first movable image-pickup unit 21 is included in a part of the manipulator MNP1 configuring the first arm. The first movable image-pickup unit 21 is capable of moving according to the motion of the first arm. When the target object W1 or W2 is gripped by the hand HND2, the first movable image-pickup unit 21 is set in a position where the first movable image-pickup unit 21 is capable of picking up an image of a range including the target object W1 or W2 gripped by the hand HND2 according to the motion of the first arm. In the following explanation, a picked-up image picked up by the first movable image-pickup unit 21 is referred to as first movable picked-up image.

Note that the first movable image-pickup unit 21 is configured to pick up a still image in the range as the first movable picked-up image. Instead, the first movable image-pickup unit 21 may be configured to pick up a moving image in the range as the first movable picked-up image.

The force sensor 23 included in the first arm is provided between the hand HND1 and the manipulator MNP1 of the first arm. The force sensor 23 detects a force or a moment acting on the hand HND1 and the finger sections N1 to N4. The force sensor 23 outputs information indicating the detected force or moment to the control apparatus 30 through communication. The information indicating the force or the moment detected by the force sensor 23 is used for, for example, compliant motion control of the robot 20 by the control apparatus 30.

The second arm is a six-axis vertical articulated type. The manipulator MNP2 and the hand HND2 can perform operation in a six-axis degree of freedom according to associated operation by the actuators. The second arm includes the second movable image-pickup unit 22 and the force sensor 23.

The second movable image-pickup unit 22 is, for example, a camera including a CCD or a CMOS, which is an image pickup device that converts condensed light into an electric signal.

Note that the second arm may operate in five degrees of freedom (five axes) or less or may operate in seven degrees of freedom (seven axes) or more.

The second movable image-pickup unit 22 is communicably connected to the control apparatus 30 by a cable. Wired communication via the cable is performed according to a standard such as an Ethernet (registered trademark) or a USB (Universal Serial bus). Note that the second movable image-pickup unit 22 and the control apparatus 30 may be connected by radio communication performed according to a communication standard such as Wi-Fi (registered trademark).

As shown in FIG. 1, the second movable image-pickup unit 22 is included in a part of the manipulator MNP2 configuring the second arm. The second movable image-pickup unit 22 is capable of moving according to the motion of the second arm. When the target object W1 or W2 is gripped by the hand HND1, the second movable image-pickup unit 22 is set in a position where the second movable image-pickup unit 22 is capable of picking up an image of a range including the target object W1 or W2 gripped by the hand HND1 according to the motion of the first arm. In the following explanation, a picked-up image picked up by the second movable image-pickup unit 22 is referred to as second movable picked-up image.

Note that the second movable image-pickup unit 22 is configured to pick up a still image in the range as the second movable picked-up image. Instead, the second movable image-pickup unit 22 may be configured to pick up a moving image in the range as the second movable picked-up image.

The force sensor 23 included in the second arm is provided between the hand HND2 and the manipulator MNP2 of the second arm. The force sensor 23 detects a force or a moment acting on the hand HND2 and the finger sections N1 to N4. The force sensor 23 outputs information indicating the detected force or moment to the control apparatus 30 through communication. The information indicating the force or the moment detected by the force sensor 23 is used for, for example, compliant motion control of the robot 20 by the control apparatus 30.

The image pickup unit 10 includes a first fixed image-pickup unit 11 and a second fixed image-pickup unit 12. The image pickup unit 10 is a stereo image pickup unit configured by the two image pickup units.

Note that the image pickup unit 10 may be configured by three or more image pickup units instead of being configured by the two image pickup units or may be configured to pick up a two-dimensional image with one image pickup unit. In this embodiment, as shown in FIG. 1, the image pickup unit 10 is set at the top section of the robot 20 as a part of the robot 20. Instead, the image pickup unit 10 may be set in a position different from the robot 20 as a separate body from the robot 20.

The first fixed image-pickup unit 11 is, for example, a camera including a CCD or a CMOS, which is an image pickup device that converts condensed light into an electric signal. The first fixed image-pickup unit 11 is communicably connected to the control apparatus 30 by a cable. Wired communication via the cable is performed according to a standard such as an Ethernet (registered trademark) or a USB. Note that the first fixed image-pickup unit 11 and the control apparatus 30 may be connected by radio communication performed according to a communication standard such as Wi-Fi (registered trademark).

The first fixed image-pickup unit 11 is set in a position where the first fixed image-pickup unit 11 is capable of picking up an image of a range including the entire surface of a top plate of the workbench T (FIG. 1) on which the target object W1 or the target object W2 is placed. In the following explanation, a still image picked up by the first fixed image-pickup unit 11 is referred to as first fixed picked-up image. Note that the first fixed image-pickup unit 11 is configured to pick up the still image in the range as the first fixed picked-up image. Instead, the first fixed image-pickup unit 11 may be configured to pick up a moving image in the range as the first fixed picked-up image.

The second fixed image-pickup unit 12 is, for example, a camera including a CCD or a CMOS, which is an image pickup device that converts condensed light into an electric signal. The second fixed image-pickup unit 12 is communicably connected to the control apparatus 30 by a cable. Wired communication via the cable is performed according to a standard such as an Ethernet (registered trademark) or a USB. Note that the second fixed image-pickup unit 12 and the control apparatus 30 may be connected by radio communication performed according to a communication standard such as Wi-Fi (registered trademark).

The second fixed image-pickup unit 12 is set in a position where the second fixed image-pickup unit 12 is capable of picking up an image of a range same as the range of the first fixed image-pickup unit 11. In the following explanation, a still image picked up by the second fixed image-pickup unit 12 is referred to as second fixed picked-up image. Note that the second fixed image-pickup unit 12 is configured to pick up the still image in the range as the second fixed picked-up image. Instead, the second fixed image-pickup unit 12 may be configured to pick up a moving image in the range as the second fixed picked-up image. In the following explanation, for convenience of explanation, the first fixed picked-up image and the second fixed picked-up image are collectively referred to as stereo picked-up image.

The robot 20 is communicably connected to the control apparatus 30 incorporated in the robot 20 by, for example, a cable. Wired communication via the cable is performed according to a standard such as an Ethernet (registered trademark) or a USB. Note that the robot 20 and the control apparatus 30 may be connected by radio communication performed according to a communication standard such as Wi-Fi (registered trademark).

In this embodiment, the robot 20 acquires a control signal from the control apparatus 30 incorporated in the robot 20 and performs, on the basis of the acquired control signal, re-holding processing of the target object W1 and the target object W2. In the following explanation, a mode is explained in which the hand HND1 of the first arm performs the re-holding processing of the target object W1 or the target object W2.

Note that, in the following explanation, operations performed by the first arm may be performed by the second arm. Operations performed by the second arm may be performed by the first arm. In other words, the hand HND2 may perform the re-holding processing. In this case, the operations performed by the first arm and the second arm are interchanged in the following explanation.

The control apparatus 30 controls the robot 20 on the basis of the stereo picked-up image picked up by the image pickup unit 10, the first movable picked-up image picked up by the first movable image-pickup unit 21, and the second movable picked-up image picked up by the second image pickup unit 22.

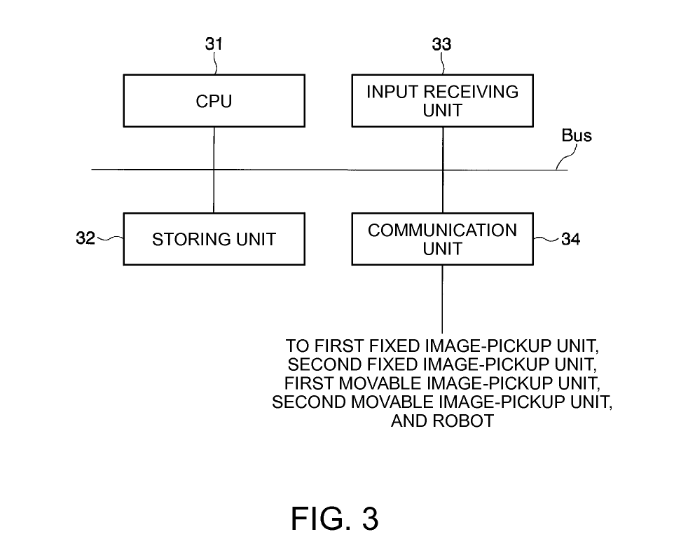

The schematic configuration of the control apparatus 30 is explained with reference to FIG. 3.

FIG. 3 is a diagram showing an example of the schematic hardware configuration of the control apparatus 30.

The control apparatus 30 includes, for example, a CPU (Central Processing Unit) 31, a storing unit 32, an input receiving unit 33, and a communication unit 34. The control apparatus 30 performs communication with the first fixed image-pickup unit 11, the second fixed image-pickup unit 12, the first movable image-pickup unit 21, the second movable image-pickup unit 22, and the force sensor 23 via the communication unit 34. These components are connected to be capable of communicating with one another via a bus Bus. The CPU 31 executes various computer programs stored in the storing unit 32.

The storing unit 32 includes, for example, a ROM (Read Only Memory), a RAM (Random Access Memory), or an EEPROM (Electrically Erasable Programmable Read Only Memory). The storing unit 32 may include an auxiliary storage device such as a HDD (Hard Disc Drive) or a flash memory. The storing unit 32 stores various computer programs to be executed by the CPU 31, various kinds of information and images to be processed by the CPU 31, a result of processing executed by the CPU 31, and the like. Note that the storing unit 32 may be an external storage device connected by a digital input/output port such as a USB instead of the storage device incorporated in the control apparatus 30.

The input receiving unit 33 is, for example, a keyboard, a mouse, a touch pad, or other input devices. Note that the input receiving unit 33 may function as a display unit and may be configured as a touch panel.

The communication unit 34 includes, for example, a digital input/output port such as a USB or an Ethernet port.

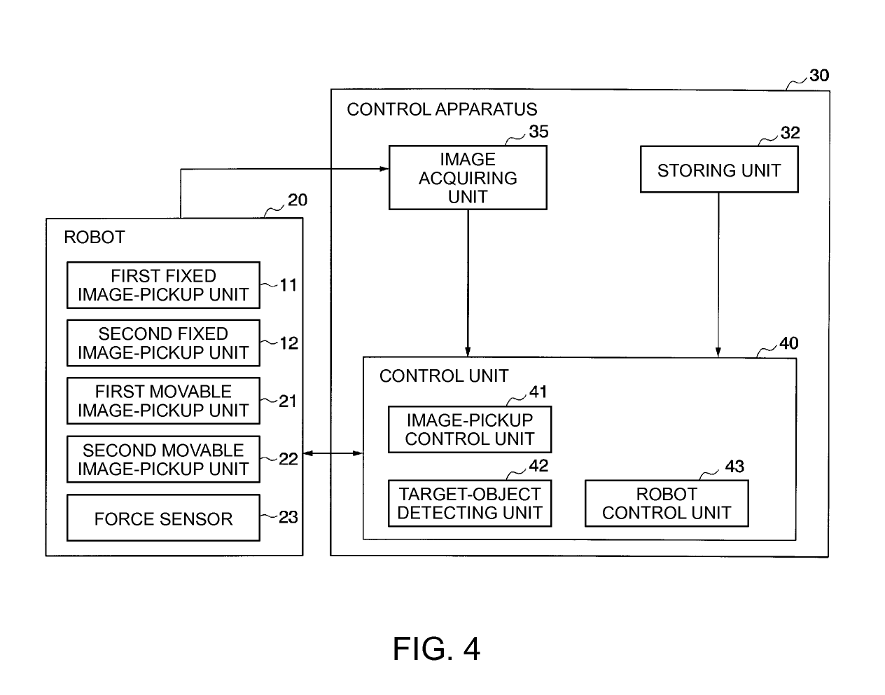

FIG. 4 is a block diagram showing the schematic functional configuration of the control apparatus 30.

The control apparatus 30 includes a storing unit 32, an image acquiring unit 35, and a control unit 40. A part or all of the functional units included in the control unit 40 are realized by, for example, the CPU 31 executing the various computer programs stored in the storing unit 32. A part or all of the functional units may be realized by hardware such as an LSI (Large Scale Integration) or an ASIC (Application Specific Integrated Circuit).

The image acquiring unit 35 acquires, from the robot 20, the stereo picked-up image picked up by the image pickup unit 10. The image acquiring unit 35 outputs the acquired stereo picked-up image to the control unit 40. The image acquiring unit 35 acquires, from the robot 20, the first movable picked-up image picked up by the first movable image-pickup unit 21. The image acquiring unit 35 outputs the acquired first movable picked-up image to the control unit 40. The image acquiring unit 35 acquires, from the robot 20, the second movable picked-up image picked up by the second movable image-pickup unit 22. The image acquiring unit 35 outputs the acquired second movable picked-up image to the control unit 40.

An image-pickup control unit 41 controls the image pickup unit 10 to pick up the stereo picked-up image. More specifically, the image-pickup control unit 41 controls the first fixed image-pickup unit 11 to pick up the first fixed picked-up image and controls the second fixed image-pickup unit to pick up the second fixed picked-up image. The image-pickup control unit 41 controls the first movable image-pickup unit 21 to pick up the first movable picked-up image. The image-pickup control unit 41 controls the second movable image-pickup unit 22 to pick up the second movable picked-up image.

A target-object detecting unit 42 detects the position and the posture of the target object W1 or the target object W2 on the basis of the stereo picked-up image acquired by the image acquiring unit 35. More specifically, the target-object detecting unit 42 reads an image (a picked-up image, a CG (Computer Graphics), etc.) of the target object W1 or the target object W2 stored by the storing unit 32 and detects the position and the posture of the target object W1 or the target object W2 from the stereo picked-up image with pattern matching based on the read image of the target object W1 or the target object W2.

Note that, instead of detecting the position of the target object W1 or the target object W2 with the pattern matching, the target-object detecting unit 42 may be configured to, for example, read the position of the target object W1 or the target object W2 stored in the storing unit 32 in advance or may be configured to detect the target object W1 or the target object W2, for example, detect, from the stereo picked-up image, the position of the target object W1 or the target object W2 with a marker or the like stuck to the target object W1 or the target object W2.

A robot control unit 43 controls the operation of the robot 20 on the basis of the image acquired by the image acquiring unit 35, the position and the posture of the target object W1 or the target object W2 detected by the target-object detecting unit 42, and the various kinds of information stored by the storing unit 32. In the following explanation, the re-holding processing of the target object W1 or the target object W2 by the robot control unit 43 is explained. The robot control unit 43 controls the robot 20 on the basis of the position of the target object W1 or the target object W2 detected by the target-object detecting unit 42 to move, with visual servo or the like, the hand HND1 or the hand HND2 to a position where the hand HND1 or the hand HND2 can grip the target object W1 or the target object W2. The robot control unit 43 controls the robot 20 to cause, with impedance control or the like, the hand HND1 or the hand HND2 to grip the target object W1 or the target object W2. The robot control unit 43 controls the robot 20 to move, with the visual servo or the like, the hand HND1 or the hand HND2, which grips the target object W1 or the target object W2, to a predetermined position. The predetermined position is a position where the hand HND1 or the hand HND2 is unlikely to collide against an obstacle in performing operations explained below and may be any position.

The robot control unit 43 controls the robot 20 with the visual servo or the like to move the hand HND1 to a position where contact surfaces of the finger sections N1 to N4 with the target object are higher than the placing section P in the gravity direction. The contact surfaces of the finger sections N1 to N4 and the target object W1 or the target object W2 refer to surfaces on which the finger sections N1 to N4 press the target object W1 or the target object W2 in gripping. “The contact surfaces of the finger sections N1 to N4 and the target object are higher than the placing section P” means that, for example, when the target object W1 is released from the gripping, if the position in the horizontal direction of the target object W1 overlaps the placing section P when the target object W1 moves according to the gravity, the target object W1 comes into contact with the placing section P. Note that the positions in the horizontal direction of the target object W1 and the placing section P do not have to actually coincide with each other. The target object W1 and the placing section P may be located obliquely from each other. “The contact surfaces of the finger sections N1 to N4 and the target object are higher than the placing section P” means that, for example, when power limit points in the gravity direction are compared at points included in surfaces where the finger sections N1 to N4 are in contact with the target object W1 or the target object W2 and points included in surfaces where the target object W1 and the target object W2 can be placed on the placing section P, the points included in the surfaces on which the finger sections N1 to N4 are in contact with the target object W1 are present in a higher position.

The robot control unit 43 controls the robot 20 to reduce, with the impedance control or the like, a gripping force by the hand HND1 or the hand HND2 and releases the target object W1 or the target object W2 from the gripping. At this point, the target object W1 or the target object W2 changes to a state in which the target object W1 or the target object W2 is not fixed by the pressing of the finger sections N1 to N4. However, the target object W1 or the target object W2 is placed on the finger sections N1 to N4 or the placing section P. The robot control unit 43 controls the robot 20 to increase, with the impedance control or the like, the gripping force by the hand HND1 or the hand HND2 and grip the target object W1 or the target object W2 again.

The operation of the robot system 1 is explained.

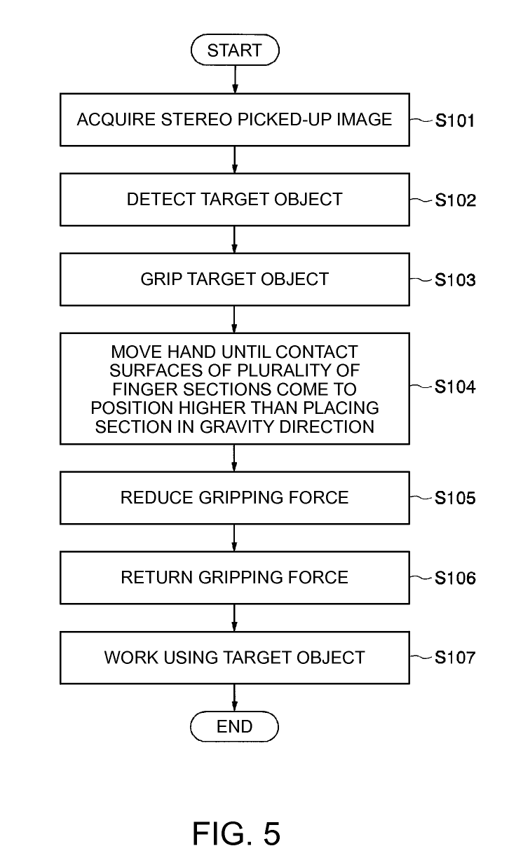

FIG. 5 is a flowchart for explaining an example of a flow of the re-holding processing by the control unit 40.

(Step S101) First, the control unit 40 acquires, from the image pickup unit 10, a stereo picked-up image including the target object W1 or the target object W2 placed on the workbench T. Thereafter, the control unit 40 advances the processing to step S102.

(Step S102) Subsequently, the control unit 40 detects the target object W1 or the target object W2 from the acquired stereo picked-up image. Thereafter, the control unit 40 advances the processing to step S103.

(Step S103) Subsequently, the control unit 40 controls the robot 20 to grip the target object W1 or the target object W2. Thereafter, the control unit 40 advances the processing to step S104.

(Step S104) Subsequently, the control unit 40 moves the hand HND1 or the hand HND2 until the contact surfaces of the finger sections N1 to N4 and the target object come to a position higher than the placing section P in the gravity direction. Thereafter, the control unit 40 advances the processing to step S105.

(Step S105) Subsequently, the control unit 40 controls the robot 20 to reduce the gripping force of the target object W1 or the target object W2 by the hand HND1 or the hand HND2 and release the target object W1 or the target object W2 from the gripping. Thereafter, the control unit 40 advances the processing to step S106.

(Step S106) Subsequently, the control unit 40 controls the robot 20 to increase the gripping force by the hand HND1 or the hand HND2 and grip the target object W1 or the target object W2 again. Note that, in the processing in step S105, time until the target object W1 or the target object W2 is gripped again after the target object W1 or the target object W2 are released, for example, may be set in advance for each of the target object W1 or the target object W2 or may be set on the basis of a distance that the target object W1 or the target object W2 moves when being released. The control unit 40 may perform the processing in step S106 after checking, with the stereo picked-up image or the like, a result of the processing in step S105. Thereafter, the control unit 40 advances the processing to step S107.

(Step S107) Subsequently, the control unit 40 controls the robot 20 to execute work using the gripped target object W1 or target object W2. Thereafter, the control unit 40 ends the processing shown in the figure.

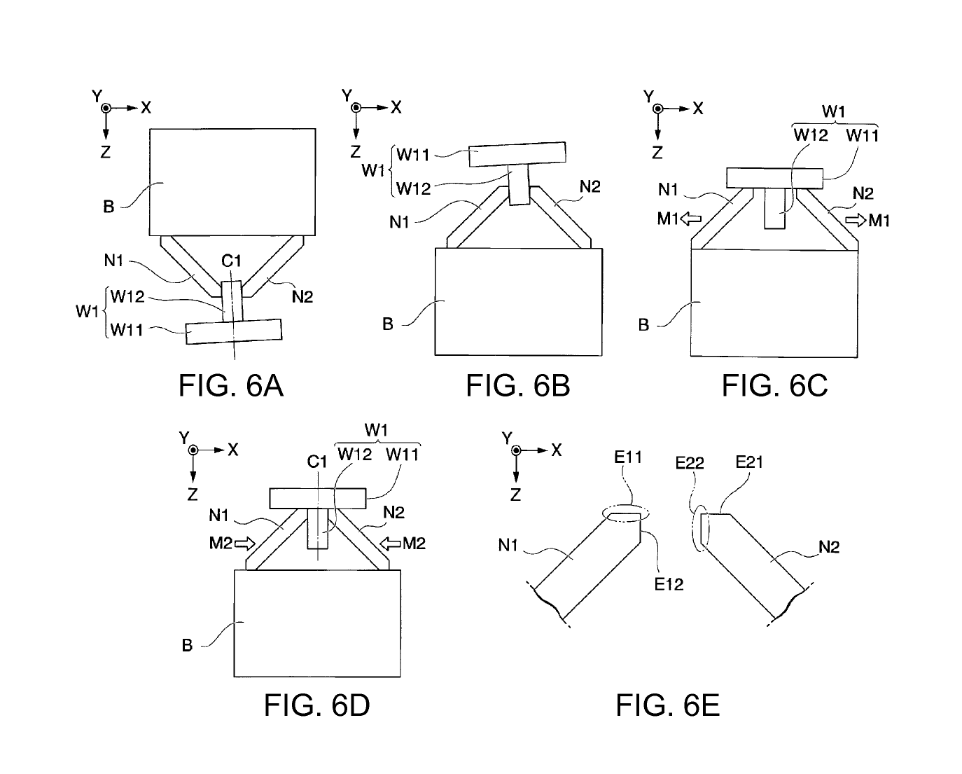

Specific examples of the operations of the robot system 1 are explained with reference to FIGS. 6A to 8D.

In FIGS. 6A to 8D, X, Y, and Z respectively indicate axes of an orthogonal coordinate system set with reference to the hand HND1. The directions of X, Y, and Z coincide with the first direction, the second direction, and the third direction in FIGS. 2A to 2C. In FIGS. 6A to 8D, the Z axis coincides with the gravity direction.

FIGS. 6A to 6E are diagrams for explaining a first example of the operation by the robot system 1.

In the first example of the operation, an example is explained in which the control unit 40 controls the robot 20 to execute the re-holding processing on the target object W1 gripped by the hand HND1. The re-holding processing is performed for the purpose of matching a center axis C1 (FIG. 6A) in the target object W1 having the stepped cylindrical shape with a center axis C2 (FIG. 7A) in the third direction in the base B.

FIGS. 6A to 6D are model diagrams showing states of the position and the posture of the hand HND1 in the steps of the re-holding processing. FIGS. 6A to 6D are side views of the hand HND1 viewed from the finger sections N1 and N2 side.

FIG. 6A shows an example of a state in which the hand HND1 grips the target object W1 according to the processing in step S103 (FIG. 5). In the example shown in the figure, the hand HND1 grips the protrusion W12 of the target object W1. The center axis C1 of the cylindrical shape of the target object W1 gripped by the hand HND1 inclines without coinciding with the Z axis set with reference to the hand HND1. In this way, when the target object W1 placed on the workbench T is gripped, the target object W1 is not always gripped in the posture of the target state in the first example of the operation.

FIG. 6B shows an example in which, according to the processing in step S104 (FIG. 5), the hand HND1 is moved until the contact surfaces of the finger sections N1 to N4 and the target object W1 come to a position higher than the placing section P in the gravity direction. In the example shown in the figure, the robot control unit 43 controls the robot 20 to reverse the direction of the hand HND1 in the gravity direction from the state shown in FIG. 6A to thereby move the hand HND1 until the contact surfaces of the finger sections N1 to N4 and the target object W1 come to the position higher than the placing section P.

FIG. 6C shows a state in which the target object W1 is released from the gripping according to the processing in step S105 (FIG. 5). In the releasing, the robot control unit 43 controls the hand HND1 to move in a direction M1 in which the finger section N1 and the finger section N2 move away from each other and the finger section N3 and the finger section N4 move away from each other. At the same time, the robot control unit 43 controls the hand HND1 to move in a direction (not shown in the figure) in which the finger section N1 and the finger section N3 move away from each other and the finger section N2 and the finger section N4 move away from each other. At this point, a movement amount of the finger sections N1 to N4 is set to a very small amount enough for preventing the target object W1 released from the gripping from dropping. Consequently, since the force of the finger sections N1 to N4 pressing the target object W1 decreases, the target object W1 moves in the gravity direction. The target object W1 is placed on the finger sections N1 to N4. As shown in the figure, in the first example of the operation, the target object W1 released from the gripping comes into contact with the finger sections N1 to N4.

FIG. 6D shows a state in which the hand HND1 grips the target object W1 again according to the processing in step S106 (FIG. 5). When the hand HND1 grips the target object W1 again, the robot control unit 43 controls the hand HND1 to move in a direction M2 in which the finger section N1 and the finger section N2 move close to each other and the finger section N3 and the finger section N4 move close to each other. At the same time, the robot control unit 43 controls the hand HND1 to move in a direction (not shown in the figure) in which the finger section N1 and the finger section N3 move close to each other and the finger section N2 and the finger section N4 move close to each other. At this point, the finger sections N1 to N4 move toward the center axis C2 in the third direction in the base B. Consequently, the finger sections N1 to N4 come into contact with the surface on the protrusion side of the substrate W11 and grip the protrusion W12 while maintaining parallelism of the upper surfaces of the finger sections N1 to N4 and the surface on the protrusion side of the target object W1. That is, when the hand HND1 grips the target object W1 again, the posture of the target object W1 with respect to the hand HND1 is decided according to the contact with the surface on the protrusion side of the substrate W11. Therefore, the control unit 40 can cause the robot 20 to grip the target object W1 in a desired position and a desired posture with respect to the hand HND1. When the hand HND1 grips the target object W1 again, a force equal to or larger than the mass of the target object W1 is not applied to the target object W1 in the gravity direction. Therefore, it is possible to avoid breakage of the target object W1.

Note that, in this embodiment, “parallel” does not have to be strictly parallel. In implementation, deviation of a tilt not affecting the implementation may occur.

FIG. 6E is a diagram showing functional parts of the finger sections N1 to N4 during the re-holding processing.

In the example of the operation explained above, the finger sections N1 to N4 have the two functions of the retention by the placing of the target object W1 and the pressing of the target object W1. An upper surface E11 at the distal end of the finger section N1 and an upper surface E21 at the distal end of the finger section N2 come into contact with the target object W1 released from the gripping in step S105 (FIG. 5) and place the target object W1. The upper surface is, for example, a surface present in the highest position in the gravity direction. Upper surfaces of the finger sections N1 to N4 in the first example of the operation are surfaces in contact with the target object W1 released from the gripping. A surface E12 and a surface E22 opposed to each other at the distal end of the finger section N1 and the distal end of the finger section N2 come into contact with and press the target object W1 in the processing in step S103 (FIG. 5) and step S106 (FIG. 5). In this way, when gripping the target object W1, the finger sections N1 and N2 come into contact with the target object W1 respectively on the surface E12 and the surface E22 at the end portions in the moving direction of the finger sections N1 to N4.

FIGS. 7A and 7B are top views showing a positional relation between the finger sections N1 to N4 of the hand HND1 included in the robot 20 and the target object W1.

FIG. 7A is a top view corresponding to FIG. 6A.

In an example shown in the figure, the center axis C1 of the cylindrical shape of the target object W1 gripped by the hand HND1 does not coincide with the action center (the center axis in the third direction in the base B) C2 of the finger sections N1 to N4. The target object W1 is gripped in an eccentric state. In this way, when the target object W1 placed on the workbench T is gripped, the target object W1 is not always gripped in a desired state of the position and the posture of the target object W1. Note that the action center refers to a target point of destinations to which the finger sections N1 to N4 are respectively moved. In other words, the action center is a specific point of a destination to which the position of the center axis C1 of the target object W1 is converged.

FIG. 7B is a top view corresponding to FIG. 6D.

In an example shown in the figure, the center axis C1 of the cylindrical shape of the target object W1 gripped by the hand HND1 coincides with the action center C2 of the finger sections N1 to N4. As explained with reference to FIG. 6D, in the processing in step S106 (FIG. 5), the finger sections N1 to N4 grip the protrusion W12 while coming into contact with the surface on the protrusion side of the substrate W11. When the target object W1 is gripped again, the posture of the target object W1 with respect to the hand HND1 is decided by the contact with the surface on the protrusion side of the substrate W11. The finger sections N1 to N4 move to converge on the action center C2. Therefore, the protrusion W12 is pushed by the finger sections N1 to N4. The center axis C1 converges on the action center C2 of the finger sections N1 to N4. In the first example of the operation, directions in which the finger sections N1 to N4 are moved cross on the XY plane. Therefore, the position of the center axis C1 of the target object W1 is decided in the X-axis direction and the Y-axis direction. As a result, at the end of the processing in step S106 (FIG. 5), in a state in which the center axis C1 of the target object W1 coincides with the action center of the finger sections N1 to N4, that is, the center axis C2 (FIG. 7A) in the third direction in the base B, the target object W1 is gripped by the hand HND1. The operation for aligning the center axis is realized by, for example, moving a plurality of finger sections toward the same action center. In this way, the control unit 40 can cause the robot 20 to grip the target object W1 in the desired position and the desired posture with respect to the hand HND1.

In the example shown in the figure, the action center C2 is explained as the point on the center axis in the third direction in the base B. However, the action center C2 is not limited to this. For example, the control unit 40 may move the finger sections N1 to N4 toward a point other than the point on the center axis in the third direction in the base B. The control unit 40 may move the finger sections N1 to N4 only in a specific direction on the XY plane. For example, the control unit 40 controls the hand HND1 to move in the direction M2 in which the finger section N1 and the finger section N2 move close to each other and the finger section N3 and the finger section N4 move close to each other. At this point, by moving the finger sections N1 to N4 toward a specific surface orthogonal to the direction M2, the hand HND1 can converge the center axis C1 of the target object W1 on the surface orthogonal to the direction M2.

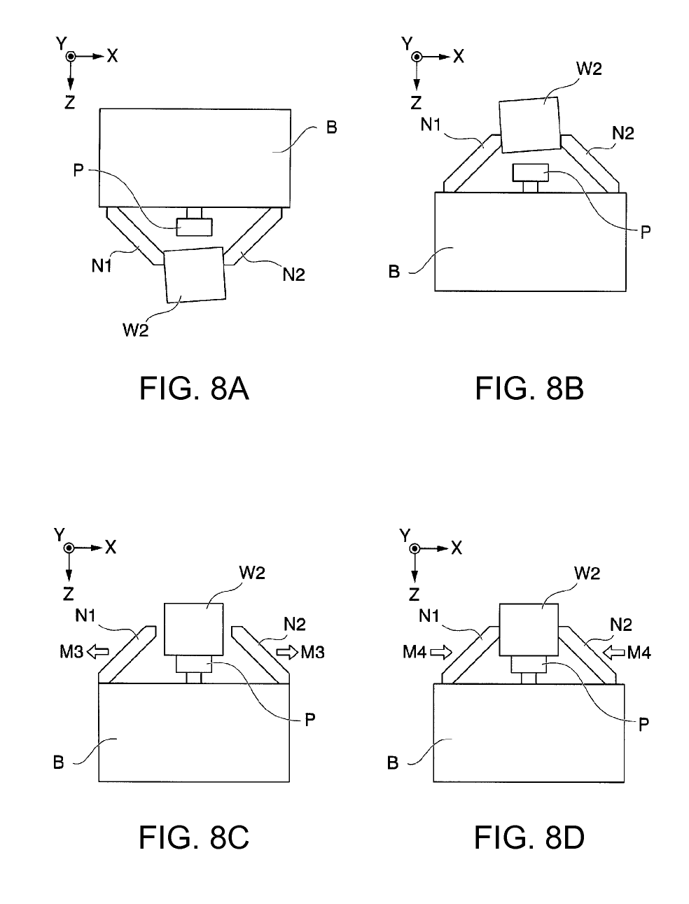

FIGS. 8A to 8D are diagrams for explaining a second example of the operation by the robot system 1.

In the second example of the operation, an example is explained in which the control unit 40 controls the robot 20 to execute the re-holding processing on the rectangular parallelepiped object W2 gripped by the hand HND1. The re-holding processing is performed for the purpose of setting a plane on the base B side of the target object W2 parallel to a surface (the XY plane) perpendicular to the third direction in the base B.

FIGS. 8A to 8D are model diagrams showing a state of the position and the posture of the hand HND1 in the steps of the re-holding processing. FIGS. 8A to 8D are side views of the hand HND1 viewed from the finger sections N1 and N2 side (the first direction).

FIG. 8A shows an example of a state in which the hand HND1 grips the target object W2 according to the processing in step S103 (FIG. 5). In the example shown in the figure, the hand HND1 grips the side surface of the target object W2. The plane on the base B side of the target object W2 gripped by the hand HND1 inclines without becoming parallel to the surface perpendicular to the third direction in the base B. In this way, when the target object W2 placed on the work bench T is gripped, the target object W2 is not always gripped in the posture of the target state in the second example of the operation.

FIG. 8B shows an example of a state in which, according to the processing in step S104 (FIG. 5), the hand HND1 is moved until the contact surfaces of the finger sections N1 to N4 and the target object W2 come to a position higher than the placing section P in the gravity direction. In the example shown in the figure, the control unit 40 controls the robot 20 to reverse the direction of the hand HND1 in the gravity direction from the state shown in FIG. 8A to thereby move the hand HND1 until the contact surfaces of the finger sections N1 to N4 and the target object W1 come to the position higher than the placing section P.

FIG. 8C shows a state in which the target object W2 is released from the gripping according to the processing in step S105 (FIG. 5). In the releasing, the robot control unit 43 controls the hand HND1 to move in a direction M3 in which the finger section N1 and the finger section N2 move away from each other and the finger section N3 and the finger section N4 move away from each other. Consequently, the force of the finger sections N1 to N4 pressing the target object W2 decreases. Therefore, the target object W2 moves in the gravity direction. The target object W2 is retained by the hand HND1 by being placed on the placing section P. As shown in the figure, in the second example of the operation, the target object W2 released from the gripping comes into contact with the placing section P.

FIG. 8D shows a state in which the hand HND1 grips the target object W2 again according to the processing in step S106 (FIG. 5). When the hand HND1 grips the target object W2 again, the robot control unit 43 controls the hand HND1 to move in a direction M4 in which the finger section N1 and the finger section N2 move close to each other and the finger section N3 and the finger section N4 move close to each other. Consequently, the finger sections N1 to N4 bring the target object W2 into contact with the upper surface of the placing section P and grip the target object W2 while maintaining parallelism of the upper surfaces of the finger sections N1 to N4 and the planes on the base B side of the target object W2 in contact with the placing section P. That is, when the hand HND1 grips the target object W2 again, the posture of the target object W2 with respect to the hand HND1 is decided by the contact of the plane on the base B side of the target object W2 and the upper surface of the placing section P. Therefore, the control unit 40 can cause the robot 20 to grip the target object W2 in a desired posture with respect to the hand HND1. When the hand HND1 grips the target object W2 again, a force equal to or larger than the mass of the target object W2 is not applied to the target object W2 in the gravity direction. Therefore, it is possible to avoid breakage of the target object W2.

As explained above, in the robot system 1 according to this embodiment, the control unit 40 controls the robot 20 to grip the target object W1 or the target object W2 with the four finger sections N1 to N4, thereafter, move the hand HND1 or the hand HND2 until the contact surfaces of the four finger sections N1 to N4 come to the position higher than the placing section P in the gravity direction, release the gripping of the target object W1 or the target object W2 by the four finger sections N1 to N4, and grip the target object W1 or the target object W2 again with the four finger sections N1 to N4. Consequently, the robot system 1 can correct the gripping posture of the target object W1 or the target object W2.

The robot 20 includes the placing section P on which the target object W1 or the target object W2 is placed when the gripping of the target object W1 or the target object W2 is released by the four finger sections N1 to N4. Consequently, in the robot system 1, the robot 20 can correct the gripping posture of the target object irrespective of the shape of the target object.

In the robot system 1, the four finger sections N1 to N4 of the robot 20 come into contact with the target object W1. Consequently, in the robot system 1, the control unit 40 can control the robot 20 to grip the released target object W1 again without addition of a new component for placing the target object W1.

In the robot system 1, the control unit 40 controls the robot 20 to move the finger sections N1 to N4 respectively toward specific points to thereby grip the target object W1 or the target object W2 again while maintaining parallelism of the surface of the target object W1 or the target object W2 in contact with the finger sections N1 to N4 or the placing section P and the upper surfaces of the finger sections N1 to N4 after the release of the gripping. Consequently, when the robot 20 grips the target object W1 again, the robot 20 can match the action center of the hand HND1 or the hand HND2 and the center of the cross section of the protrusion W12.

Note that, in the embodiment explained above, the robot system 1 does not have to include any one or more of the first fixed image-pickup unit 11, the second fixed image-pickup unit 12, the first movable image-pickup unit 21, and the second movable image-pickup unit 22.

Note that, in the mode explained above, the finger sections N1 to N4 or the placing section P retains the target object W1 or the target object W2 released from the gripping. However, the configuration of the placing section on which the target released from the gripping can be placed is not limited to this. For example, the placing section may be a structure that retains the target object with one or more surfaces like the placing section P. For example, the placing section may be a bar-like structure that retains the target object with two or more lines. For example, the placing section may be a protrusion-like structure that retains the target object with three or more points. That is, in the contact with the target object, the placing section only has to be a structure that retains the target object released from the gripping with any number of contact points, contact lines, contact surfaces, or combinations of the contact points, the contact lines, and the contact surfaces.

The placing section may be provided in a component other than the hand HND1 or the hand HND2. For example, the placing section may be integrally provided with any component of the robot 20 such as the manipulator MNP1 or the manipulator MNP2 or may be provided in any position in a work range of the robot 20.

The embodiment of the invention is explained in detail above with reference to the drawings. However, specific components are not limited to the embodiment and may be, for example, changed, replaced, and deleted without departing from the spirit of the invention.

A computer program for realizing the functions of any components in the apparatus (e.g., the control apparatus 30 of the robot system 1) explained above may be recorded in a computer-readable recording medium and may be read and executed by a computer system. Note that the “computer system” includes an OS (Operating System) and hardware such as peripheral apparatuses. The “computer-readable recording medium” refers to portable media such as a flexible disk, a magneto-optical disk, a ROM, and a CD (Compact Disk)-ROM and storage devices such as a hard disk incorporated in the computer system. Further, the “computer-readable recording medium” also includes a recording medium that retains a computer program for a fixed time such as a volatile memory RAM inside a computer system that functions as a server or a client when the computer program is transmitted via a network such as the Internet or a communication circuit such as a telephone circuit.

The computer program may be transmitted from the computer system, in which the computer program is stored in the storage medium or the like, to another computer system via a transmission medium or by a transmission wave in the transmission medium. The “transmission medium” for transmitting the computer program refers to a medium having a function of transmitting information like a network (a communication network) such as the Internet or a communication circuit (a communication line) such as a telephone circuit.

The computer program may be a computer program for realizing a part of the functions. Further, the computer program may be a computer program, a so-called differential file (a differential program), that can realize the functions explained above in a combination with a computer program already recorded in the computer system.

The entire disclosure of Japanese Patent Application No. 2014-114421, filed Jun. 2, 2014 is expressly incorporated by reference herein.

What is claimed is:

1. A robot comprising:
a hand including a plurality of finger sections and a placing section; and
a control unit configured to control the hand, wherein
the plurality of finger sections respectively include contact surfaces that come into contact with an object, and
after causing the plurality of finger sections to grip the object, the control unit moves the hand until the contact surfaces of the plurality of finger sections come to a position higher than the placing section in a gravity direction, causes the plurality of finger sections to release the gripping of the object, and causes the plurality of finger sections to grip the object again.

2. The robot according to claim 1, wherein the object is placed on the placing section when the gripping is released by the plurality of finger sections.

3. The robot according to claim 1, wherein at least two of the plurality of finger sections come into contact with the object after the release.

4. The robot according to claim 1, wherein
after the release of the gripping, the robot causes the plurality of finger sections to grip the object again by moving the plurality of finger sections respectively to specific points while maintaining parallelism of a surface of the object in contact with the plurality of finger sections or the placing section and upper surfaces of the plurality of finger sections.

5. A robot system comprising:
a robot including a hand including a plurality of finger sections and a placing section; and
a control unit configured to control the hand, wherein
the plurality of finger sections respectively include contact surfaces that come into contact with an object, and
after causing the plurality of finger sections to grip the object, the control unit moves the hand until the contact surfaces of the plurality of finger sections come to a position higher than the placing section in a gravity direction, causes the plurality of finger sections to release the gripping of the object, and causes the plurality of finger sections to grip the object again.

6. A control method for operating a robot including:
a hand including a plurality of finger sections and a placing section; the plurality of finger sections respectively including contact surfaces that come into contact with an object,
the control method comprising:
causing the plurality of finger sections to grip the object;
moving the hand until the contact surfaces of the plurality of finger sections come to a position higher than the placing section in a gravity direction;
causing the plurality of finger sections to release the gripping of the object; and
causing the plurality of finger sections to grip the object again.
